(19) United States
(12) Patent Application Publication
(10) Pub. No.: US 2018/0124064 A1
(43) Pub. Date: May 3, 2018

(54) SEPARATED APPLICATION SECURITY MANAGEMENT

(71) Applicants: Sven Schrecker, San Marcos, CA (US); Aric Shipley, Livermore, CA (US); Arlen Baker, Scottsdale, AZ (US)

(72) Inventors: Sven Schrecker, San Marcos, CA (US); Aric Shipley, Livermore, CA (US); Arlen Baker, Scottsdale, AZ (US)

(21) Appl. No.: 15/618,024

(22) Filed: Jun. 8, 2017

Related U.S. Application Data
(63) Continuation of application No. 14/583,378, filed on Dec. 26, 2014, now abandoned.
(60) Provisional application No. 62/023,035, filed on Jul. 10, 2014.
(60) Provisional application No. 62/023,080, filed on Jul. 10, 2014.

(51) Int. Cl. H04L 29/06

(52) U.S. Cl. CPC H04L 63/105; H04L 63/20; H04L 63/0869; H04L 63/1491

(57) ABSTRACT

A virtualization environment is provided to include a security management instance and an application instance. The application instance is separated from the security management instance and includes a first operating system and a particular software application. The security management instance includes a second operating system and one or more security tools to provide security for the particular application. Data for the application instance is received at the security management instance, the data is processed using at least one of the security tools, and the processed data is securely passed from the security management instance to the application instance.

This patent application claims the benefit of priority under 35 U.S.C. § 120 of U.S. Provisional Patent Application Ser. No. 62/023,035, filed Jul. 10, 2014, entitled “SEPARATED APPLICATION SECURITY MANAGEMENT” and U.S. Provisional Patent Application Ser. No. 62/023,080, filed Jul. 10, 2014, entitled “SEPARATED APPLICATION SECURITY MANAGEMENT”, which are both expressly incorporated herein by reference in their entirety.

### TECHNICAL FIELD

This disclosure relates in general to the field of computer security and, more particularly, to enhancing security for legacy systems.

### BACKGROUND

The Internet has enabled interconnection of different computer networks all over the world. The ability to effectively protect and maintain stable computers and systems, however, presents a significant obstacle for component manufacturers, system designers, and network operators. Indeed, each day thousands of new threats, vulnerabilities, and malware are identified that have the potential of damaging and compromising the security of computer systems throughout the world. Antivirus, antispyware, and other antimalware products and solutions have been developed. Some traditional antimalware products employ a host-centric approach in which the bulk of the functionality of the antimalware tool is installed onto the host, with the antimalware tool occasionally downloading an update of remediation tools, virus definition files, and other content to keep the antimalware tool abreast of newly discovered malware and other developments. The antimalware tool can then screen objects, processes, downloads, and other events on the host machine to determine whether malware exists on the host, per the content received from the updater, as well as attempt to remediate the malware using functionality available at the host-based antimalware tool. The updater can catalog various malware and code that could potentially be malware and can use this information to provide content describing malware known to the updater.

### BRIEF DESCRIPTION OF THE DRAWINGS

FIG. 1 illustrates an embodiment of a physical system.

FIG. 2 illustrates an embodiment of a physical system including physical equipment and information management systems.

FIG. 3 illustrates an embodiment of an example platform including a security management instance and application instance.

FIG. 4A illustrates an embodiment of a traditional implementation of a physical system.

FIG. 4B illustrates an implementation of the system of FIG. 4A modified using an example platform.

FIG. 5 illustrates an embodiment of an example platform including a security management instance and application instance.

FIGS. 6A-6D are flowcharts illustrating example techniques that can utilize a platform including a security management instance and application instance.

FIG. 7 is a block is a block diagram of an exemplary processor in accordance with one embodiment; and

FIG. 8 is a block diagram of an exemplary computing system in accordance with one embodiment.

Like reference numbers and designations in the various drawings indicate like elements.

### DETAILED DESCRIPTION OF EXAMPLE EMBODIMENTS

Many systems can be extraordinarily sensitive to outages, and maintaining availability of the system can be a priority. Examples of such systems include public utilities (e.g., electric, water, gas, telephone communications, etc.), traffic and transportation control (e.g., road, rail, air, etc.), military systems, and other public or private systems that are particularly sensitive to outages. Another common trait of many of these systems is that construction of the system is incremental and continuous, involving networks of organizations, vendors, and corresponding tools and computing systems providing various levels of computer-facilitated control and monitoring. Innovations within these systems may also be incremental and decentralized, with improvements and innovations occurring regularly in some sectors of the systems and slowly in others evolve slowly. Accordingly, complex and inconsistent systems can result through such development.

A system made up of a diverse and expansive array of subcomponents or subsystems may be difficult to update in a unified way, given the variety of vendors and component types in the system. As an example, an industrial or power plant can be composed of multiple different tools, transport devices, switches, valves, and sensors. The varied components can be sourced from a variety of vendors. Further, some of these components may have corresponding computing resources to assist in control and monitoring of the components. The computing resources used to assist these components can be just as diverse as the components they control, with the computing resources provided by various vendors, hosted on various computing devices, and executed on operating systems. Additionally, it may be desirable to interconnect these computing resources in a network to thereby interconnect the components controlled or monitored by the computing resources. In some cases, centralized computing systems can be provided to manage interconnected components through the computer resources controlling and/or monitoring the components.

The interconnectedness of computing resources controlling or monitoring components in a system can reflect dependencies of the components on other components in the system. For instance, two tools can be connected by a transport, such as a pipe, conveyor, or other mechanism. Additional mechanisms (e.g., valves) can be used to control the flow between the tools on the transport. Interdependencies between components can make it difficult (and expensive) to replace or update any one of the components without potentially jeopardizing other components dependent on the component, as well as corresponding computing resources.

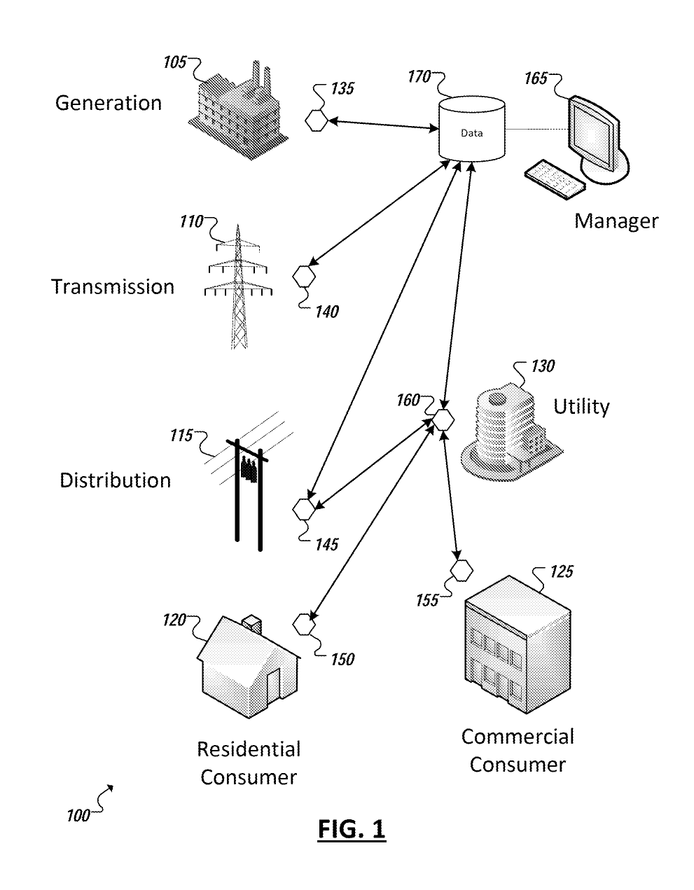

FIG. 1 is simplified block diagram illustrating a simplified representation of a system 100 that includes varied components, at least some of which are controlled and/or monitored by computing devices. In this example, a portion of a power grid is illustrated. For instance, power generation and delivery can involve multiple stages or domains. For instance, one or more power plants (e.g., 105) can be provided in a power generation domain. Transmission infrastructure (e.g., 110) can be provided to transport electricity generated at the plants over long distances and over one or more substations. A distribution network (e.g., 115) can be provided to provide stepped-down voltage to customer meter sockets at multiple customer premises, including residential consumers (e.g., 120) and commercial consumers (e.g., 125) and so on. Other stages and equipment can be provided to generate and deliver the electric power to consumers. A number of different types of equipment can be provided from potentially multiple different manufacturers and vendors across the system 100. Further facilities can be included in the system, such as, in this case, an electric utility organization 130 that can manage flow of electricity within the system and match the supply of electricity with the demand, for instance, by coordinating with other utilities to buy and sell electricity. To monitor and control performance of the system, various computer-based controllers or sensors (e.g., 135, 140, 145, 150, 155, 160) can be provided to monitor and control individual equipment across the system 100. Further, to facilitate the sophisticated interchange of information within the system to control delivery of electricity in accordance with detected demand, and other use cases, computer controllers (e.g., 135, 140, 145, 150, 155, 160) can communicate or otherwise make their data available to other computer controllers in the system (e.g., over one or more networks). For instance, a computer-implemented sensor 150 at a residential consumer 120 can communicate data to a computing device (e.g., 160) of a utility company selling electricity to the consumer, for instance, to identify demand as measured by the consumer meter (and multiple consumer meters across the network).

In addition to facilitating communication between devices used to automate monitoring and control of a system, one or more centralized management systems (e.g., 165) can be provided to leverage the information collected (or collectable) from the operation of the various computing devices implemented in the system 100. For instance, data can be collected in a data store 170, which can be mined and processed by the management system 165 to identify opportunities to further automate and optimize the interaction of the diverse components in the system.

In addition to complex, defined systems, such as infrastructure, plants, and similar systems, new ad-hoc systems and networks are emerging as more and more products and equipment evolve to communicate, through computer-implemented mechanisms, with other computing devices (and products having network communication capabilities). For instance, the phenomenon of the “internet of things” includes networks built from sensors and communication modules integrated in or attached to “things” such as equipment, toys, tools, and even living things (e.g., plants, animals, humans). Systems including connected “things” share many of the features and issues of complex and diverse connected systems, such as a varied group of vendors, various host computing devices, operating systems, software applications, and technologies. Enabling communication between such diverse devices can be problematic. Maintaining consistent standards, including security standards and policies, can be even more of a challenge.

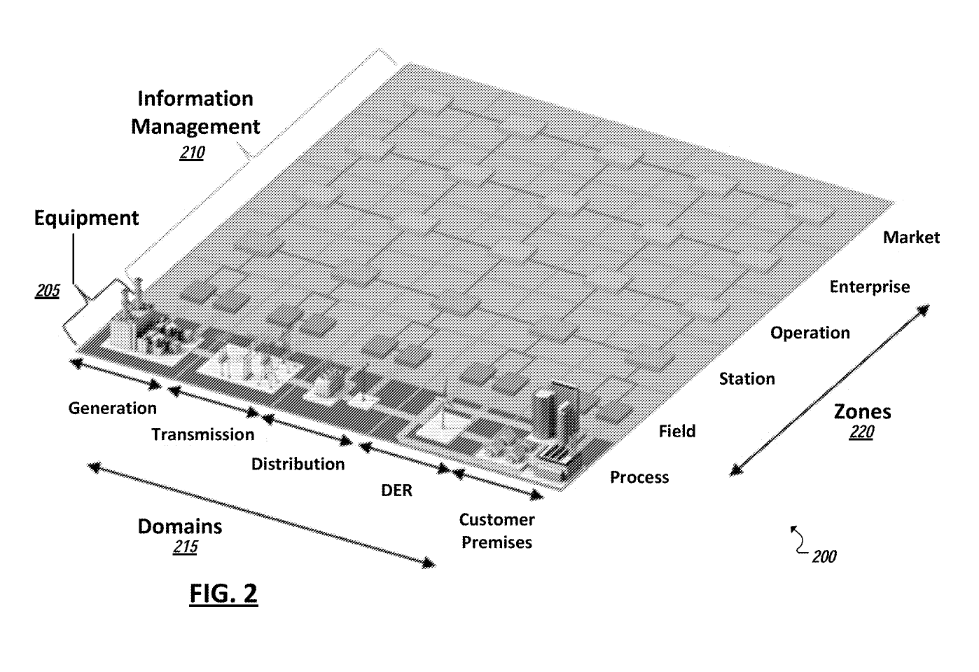

FIG. 2 illustrates another representation 200 of a complex system, such as a power grid. This representation 200 illustrates the dichotomy of physical equipment, apparatus, and things (e.g., 205) and the information management tools 210 (e.g., provided by one or more supporting computers) to connect the equipment 205 to the information management facilities of other equipment, including outside networks, such as the Internet. The diversity of the equipment 205 and computer information management tools 210 is reflected through the various domains 215 served by the system. Still further complexity is added by the various zones of information management, resulting, in some cases, in several layers of computing tools and components used to monitor and/control any one component.

The evolution toward “smart” and connected equipment, while providing substantial gains in efficiency and control, introducing and integrating computer systems (including network-connected computer systems) into equipment of systems can also introduce the myriad of vulnerabilities and threats affecting traditional computing devices and networks to equipment and systems not previously exposed to such threats. These vulnerabilities can be particularly problematic when the computer controls and networking capabilities open up critical equipment, systems, and infrastructure to abuse. However, given the diverse array of equipment employed in these systems and the similarly diverse computer controls and applications developed for such equipment, outfitting such a system with security capabilities that coherently and consistently safeguard the system can be difficult to implement. Further, given the interconnectedness of the systems, failure to safeguard one component can potentially open other components, or the system as a whole, to vulnerabilities.

As noted above, proprietary and custom software-based controls have been implemented in various devices, machines, controllers, and other equipment of various physical systems to improve the overall functionality and reliability of these systems. Many of the (software) applications developed to control and provide functionality for equipment in the system (e.g., pumps, transformers, power stations, valves, sensors, controllers, etc.) can make use of network connections to allow the applications (and computers hosting the applications) to send and receive data to and from other devices, as well as to and from “cloud”-based services, using private and/or public networks. In expansive physical systems (e.g., the electrical grid or a large Internet of Things network) the system components and their respective applications can be widely dispersed, provided (and managed) by a myriad of different vendors and owners, and can utilize a variety of different computing platforms and operating systems, (including legacy and proprietary OSes), among other challenges. Additionally, reliability and availability are often at a premium for such systems (e.g., a community cannot afford prolonged or ongoing outages in electrical or water infrastructure), and there is hesitancy within these industries for dramatic retrofitting of applications that already “work” and that would require retraining of specialized employees, periods of fault maintenance in the new software patches, etc., to say nothing of such retrofitting being prohibitively expensive to achieve across systems over the short term. Traditionally, security solutions for these software controls (or “applications”) have also often been custom-developed on a component- and application-specific basis, leading to a series of one-off (and in many cases incompatible) solutions within a far-reaching and diverse, yet interdependent, system.

In some implementations, a flexible, distributable security platform can be provided that enables a consistent platform to build security solutions upon for potentially any of a diverse array of software solutions, including custom or one-off software controls, applications of proprietary operating systems, etc. Such a platform can allow the flexibility and interoperability to facilitate widespread deployment and support of consistent security management and policy enforcement without requiring the reworking of underlying applications that are relied upon for continuous delivery of the business services provided by their physical systems.

In one example, a framework leverages principles of a separation kernel architecture on each device to deploy consistently manageable security across a system of diverse devices. Such a framework can provide for system-wide security through: 1) embedded security at each endpoint equipment computer application; 2) securing communication between endpoint components and other devices; and 3) providing consistent security policy management and security event monitoring through backend security services (e.g., such as provided by centralized security management platform and/or other backend information technology (IT) security solutions).

Such a framework can be implemented to outfit existing applications (as well as their host operating systems) with security functionality without modifying (or making only very minor modifications to) the existing applications themselves. A hypervisor can be utilized to realize a separation kernel-type system dichotomy by providing a virtualization environment in which two or more separate computing instances can be virtualized: one or more application instances and a separate security management instance. Such a platform, separates the functional (e.g., business-related) aspects of the application (or application instance(s)) from the management and security aspects (the security management instance). The security management instance can effectively wrap the application (and its native operating system) in security features provided through the security management instance by providing the security controls directly on the hardware components (e.g. physical network adapters, physical disk controller, physical peripheral controller, etc.) rather than through the virtual versions provided to the application instance(s). Therefore, the security management instance effectively sits below the application instance(s) and can intercept actions coming from the application instance's virtual components before they are implemented by the physical hardware.

In some implementations, an instance of the existing application and its native operating system can be instantiated in an Application Instance isolated and protected by a Security Management Instance to thereby protect the Application Instance and its contents. Through such an architecture, security of an existing application can be supplemented/enhanced without touching the application's own functionality or code. Traditional solutions, on the other hand, are typically developed specifically for a particular application and plug into or involve a modification of the application itself, potentially changing the workflow and functionality of the application. Further, because traditional security solutions and enhancements are often one-off, retrofitting components (and their respective applications) across a system involves engineering, in parallel, multiple, specific security solutions, patches, etc. for each individual application in the system. In systems where the exploitation of even a single component (e.g., a nuclear pump controller, or other essential component) can be catastrophic, providing a uniform, flexible platform as a security solution that is compatible across platforms and components can enable widespread and consistent deployment of security enhancements across a platform.

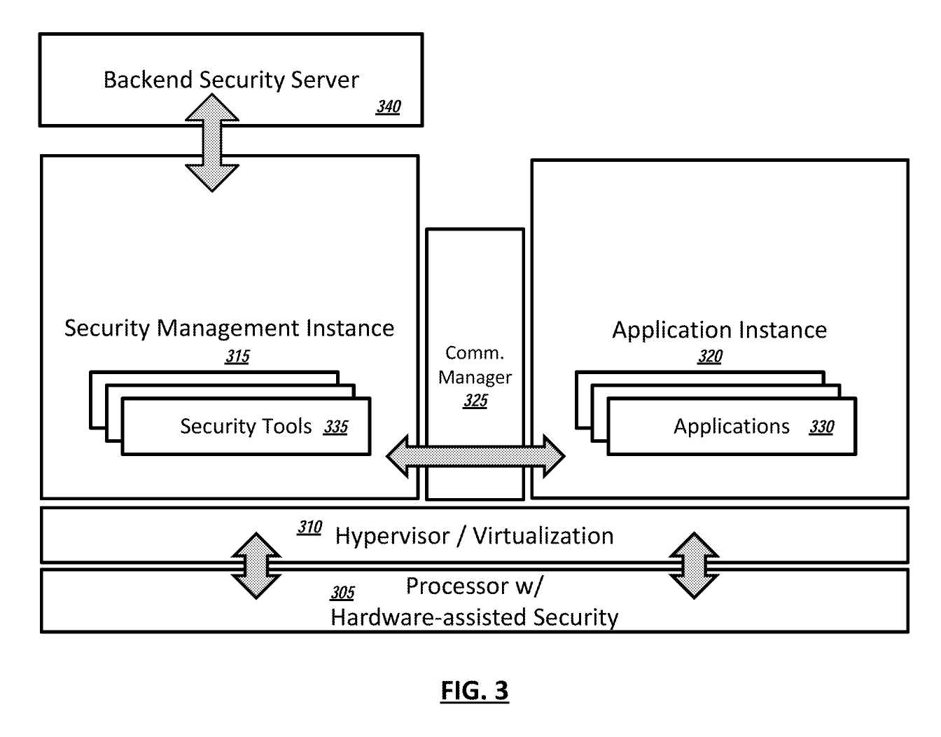

Turning to the example of FIG. 3, a simplified block diagram is shown illustrating an example of a general secure platform, instances of which can be used across a system to host a variety of different applications in the system. For instance, the platform can be built upon a secure physical processor device 305 configured to support and host virtualization environments (although conventional processor platforms may be alternatively used). The physical processor device 305 can include hardware-based security features. Such hardware-based security features can include, for instance, a trusted platform module (TPM) implemented as a separate hardware chip to securely perform cryptographic operations in support of identity, integrity, and confidentiality functions. In another example, a manageability engine can be provided on the hardware platform as a security co-processor. The processor device 305, in some instances, can provide modes of encrypted processing sessions through hardware-enforced encryption that can be implemented based on source code commands, among other examples. A secure processor 305 can represent an improvement over a native processor of a computing system provided automated monitoring and/or control of corresponding physical equipment. By so doing, security controls can be moved outside of the operating system of the environment, such that security is provided below the OS kernel of the environment.

A hypervisor, virtual machine manager, or the like (e.g., 310) can be hosted by executed by the processor to host virtual machines including a management instance 315 and an application instance 320. The virtual machines can represent a virtualization of a physically distributed system, with each of the management instance and application instance appearing as a separate isolated machine. In some implementations, the hypervisor can enforce the separation between the management instance, communication manager, and application instances by creating boundaries in memory, processor (e.g., CPU) use, and other physical components (e.g., network adapters, peripherals, storage controllers, etc., among other example features.

Communication between the instances 315, 320 can be restricted to defined mechanisms such as provided through a communication manager 325. The communication manager 325 can be present itself to the application instance as virtualization of a gateway or other network interface such that the management instance (behind the communication manager) is invisible to the application instance, and believes that it is connecting directly with a network through the communication manager 325 (i.e., and not via a separate management instance 315). In some instances, a communication manager 325 can be loaded with protocol converters to allow specific protocols (e.g., used by an application instance) to be transformed into more modern and securable protocols. The communication manager 325 can implement an embedded stateful firewall including a protocol-level firewall. Additionally, the communication manager 325 can define and enforce authorization rules that describe what kind of traffic is allowed to pass between the application instance(s) and the management instance as well as between multiple application instances on the same hardware (e.g., in such instances where multiple application instances are provided on the same platform.

Continuing with the example of FIG. 3, applications 330 can be instantiated within the application instance and function just as they do on the native platform hosting the application. Further, as noted above, multiple separate application instances can be provided on a single platform and can each interface with a management instance 315 via a single communication manager 325. The communication manager 325, in such implementations, can multiplex the network communications and transactions to be processed over the management instance 315 to allow the logic and functionality of the management instance to be reused for multiple application instances. The communication manager 325 can also secure communications between the multiple application instances, among other examples.

All or a portion of the native platform can be replaced by the platform shown and described in connection with FIG. 3. This allows the application to proceed as it always had, but with a cloak of security provided by security tools 335 of the management instance 315 and the protections provided through the secure processor 305, hypervisor 310, and other enhanced components of the platform. Further, the management instance 315 can contribute functionality (without changing the application 330) that allows backend and cloud-based security management systems and services (e.g., 340) to participate in the management and protection of the application instance (and applications 330 executed in the application instance).

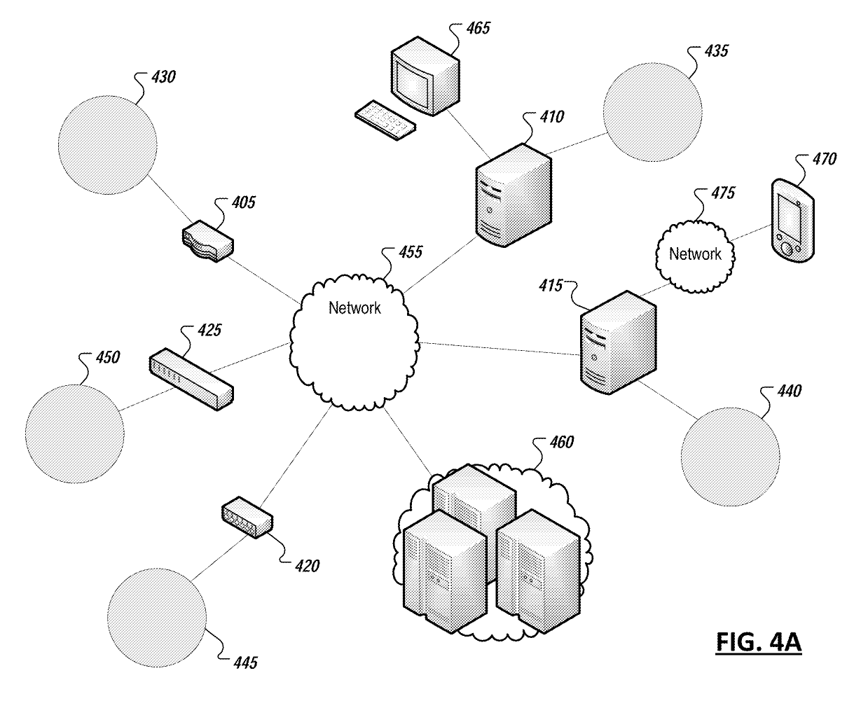

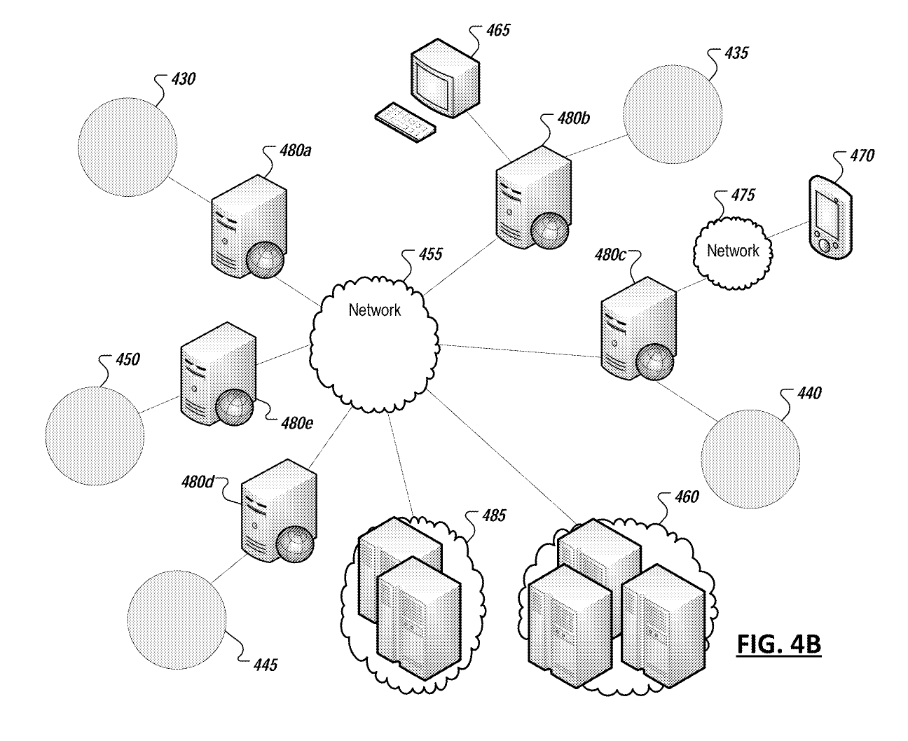

Turning to the examples of FIGS. 4A-4B, in FIG. 4A, an example network of computing devices 405, 410, 415, 420, 425 can be provided, each with one or more resident applications used to control, monitor, automate, or otherwise manage corresponding equipment (e.g., 430, 435, 440, 445, 450) within a system, such as an electrical power grid, traffic control system, water system, air traffic control system, network of internet of things devices, etc. At least some of the computing devices 405, 410, 415, 420, 425 can be communicatively connected, for instance, using a network 455, and some can access (or be accessed by) and be connected (directly or indirectly) to the internet and remote computing devices thereon (e.g., 460). Various operating systems can be employed on each of computing devices 405, 410, 415, 420, 425, as well as varying applications with varying functions (corresponding to the various types and functions of equipment 430, 435, 440, 445, 450). In some instances, applications can have user interfaces providing for some level of human user control, management, and interaction. Various user computing devices (e.g., 465, 470) can facilitate the human I/O corresponding to the application, including remote user computing devices connecting and interacting with the hosted application over a private network (e.g., 475), such as instances where remote computing devices (e.g., 470) may be used by field operators interfacing with an application hosted in another facility, among other examples.

As can be appreciated by the example of FIG. 4A, computing devices 405, 410, 415, 420, 425 can be interconnected threats or vulnerabilities on one device can effectively threaten other devices connected to it. Further, certain policies may be desired within the network of devices, such as governmental, enterprise, or other policies, including security policies. However, not every device 405, 410, 415, 420, 425 may be equipped to enforce these policies. Indeed, some devices may have no modern security features implemented on them. This can result in uneven or inconsistent enforcement of policies, or the adoption of inadequate policies tailored to cater to the lower common denominator within the network. While ad hoc security enhancements can be developed and deployed on a piecemeal basis to the various computing devices, the size, technological diversity, and ownership of the network may make the end-to-end securing of the network prohibitively difficult.

Turning to FIG. 4B, a platform, such as one adopting one or more of the principles described herein, can be provided to virtualize and replace the computing devices (e.g., 405, 410, 415, 420, 425) hosting their respective applications (and potentially possessing vulnerabilities that allow unauthorized or malicious access or control of the equipment (e.g., 430, 435, 440, 445, 450) controlled or managed by the applications). For instance, platform systems 480a-e can be deployed, each with an instance of the corresponding operating system and application(s) of the original system (e.g., 405, 410, 415, 420, 425) instantiated in a respective application instance of the platform system, with enhanced security provided by a respective security management instance of the platform system (e.g., 480a-e). A minimum baseline of security protections, rules, and policies and a common set of security functionality and tools can be provided through the security management instance included on each of the platform systems 480a-e. In some cases, the core security management functionality can be extended to include additional security tools and support other policies that are specific or unique to a given application, guest operating system, or equipment (e.g., 430, 435, 440, 445, 450) corresponding to the computing device (e.g., 405, 410, 415, 420, 425) virtualized by the corresponding platform system 480a-e. Further, one or more backend security services (e.g., 485) can be provided that can be connected to securely by each of the management instances of the platform systems 480a-e, to provide updated and/or dynamic security analysis and support, including situational and behavioral analysis, policy updates, among other features and services.

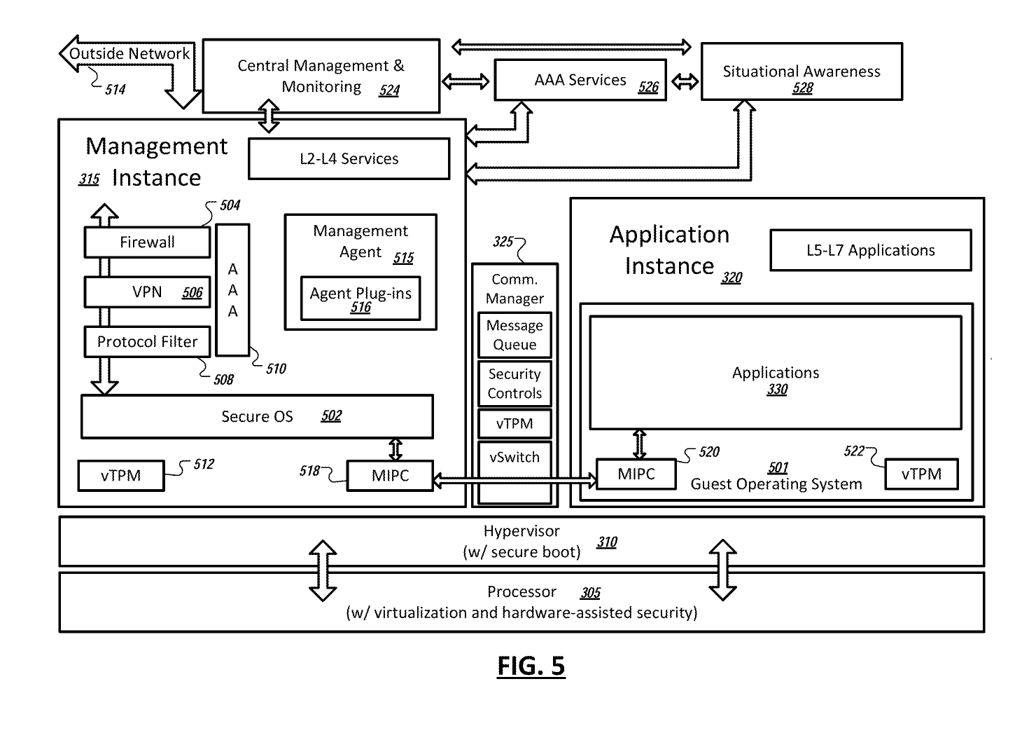

FIG. 5 is a simplified block diagram showing a more detailed representation of a particular example instance of a platform for standardizing security across a variety of different computing devices in a system. The application instance can incorporate the operating system 501 and application 330 used to automate, control, monitor, or otherwise manage physical equipment, electrical equipment, virtual equipment, or other business assets included in a business system. The application instance 320 can represent an effectively unchanged virtualized instance of the application 330 and operating system 501. Accordingly, the application and its operating system can be deployed on the platform through a hypervisor 310 that allows virtualization of a separation kernel construct and redeployment of the application instance in its unmodified form. In some cases, additional components and drivers can be provided to simplify and optimize communication between the application instance and its corresponding management instance.

The management instance 315 can envelop the application instance 320 in enhanced security. The tools and components of the management instance 315 can be executed on a secure operating system 502 that includes functionality to harden the operating system from attacks generally, as well as specifically guard against attacks targeting the management instance 315. such as among other examples. For instance, an operating system can be layered with security features such as memory randomization, intrusion detection and prevention tools, among other examples. In addition to security tools configured to protect the integrity of the management instance itself, the management instance 315 can include various tools to protect the application instance 320. For instance, a management instance 315 can include various security components and logic, such as a firewall 504, virtual private network (VPN) manager 506, protocol filter 508, authentication, authorization and accounting module 510, among other tools, such as a virtual trusted platform module (vTPM) 512.

In some implementations, the management instance 315 can effectively encapsulate the application instance 320 such that all incoming and outgoing communications involving the application instance 320 can be intercepted, processed, and secured using security tools of the security management instance, that all peripheral inputs for the application can be monitored (e.g., intercepted and analyzed) and secured by the security management instance, and all data reads and writes by the application can be monitored and secured by the security management instance.

The extent to which the security tools perform such protection can be dictated by policies applied at the security management instance. For network communications entering and exiting the application instance (through the security management instance), data of the communications can be passed to and from the application instance 320 through the security management instance 315 (via the communication manager 325). The communication manager can secure the communications between the security management instance and application instance. To facilitate quick communication, the communication manager can facilitate such communication through messages passed through secure memory shared by the application instance and security management instance. The communication manager can also emulate a network connection, such that the security management instance's interception and processing of network communications of the application are invisible to the application and its operating system. For instance, the messages of the communication manager to and from the application instance can be TCP/IP, XML, or other messages.

In one example implementation, to facilitate (secure) communication between the management instance 315 and application instance 320, a communication manager 320 can be provided to facilitate and act as a secure gateway for the communication. For instance, the communication manager can be implemented using multi-instance interprocess controllers (MIPC) 518, 520 that enable virtual machine communications internally using shared memory by mapping pre-defined communication protocols (e.g., TCP/IP) over the shared memory communications, thereby allowing different virtual machines to communication using these protocols. Sharing messages over shared memory can allow fast and secure communication over the hypervisor 310 to emulate a network connection and address any vulnerabilities inherent in the hypervisor alone. between the management and application instances (e.g., using TCP/IP messages over MIPC).

Deploying security functionality at the management instance “hides” the security from the application. The management instance acts as a secured gatekeeper for all network communications (e.g., to outside networks 514) as well as all memory reads/writes by the application instance. The management instance also possesses the ability to manage capabilities of the application instance (e.g., performing measured secure boot with remote attestation, among other functions). For instance, a secure boot can be used, by which a trusted execution environment (TEE) can measure the boot process of the platform hardware and attest to the integrity of it (or a particular portion of it), by comparing the present configuration of the system with a previous (or last trusted) version of the system.

An application 330 may connect to a private and/or public network (e.g., 514) to communicate with other computing devices in a system, as well as cloud-based services. The application can send data out on a virtual port and the sent data can be routed instead through the communication manager to pass the data to the management instance for processing. Management instance can establish a VPN tunnel (e.g., using VPN module 506) over which the data can be sent and can inspect the contents of the data to determine whether the application 330 and the data are in compliance with one or more policies. Further, all incoming network data destined for the application 330 can be intercepted by the management instance 315 prior to being delivered to the application instance 320. For network security, a firewall 504, VPN module 506, network intrusion detection and protection tool, an authentication, authorization, and accounting (AAA) module 510, and/or protocol filter 508 can be utilized to protect the application instance from threats originating from or utilizing the network connection. As examples, the firewall 504 can be provided to protect against malicious communications (or any other communication that is counter to a policy established for the device and its application), whether the communication is ingoing or outgoing. The management instance 315 can use the VPN endpoint 506 functionality to build a VPN tunnel for any communication between the application and the outside world (including outgoing and incoming communications). As an additional layer of security, network protocol protections can also be deployed that include protocol filters (e.g., 508) capable of monitoring traffic that does make it through the firewall on the tunnel (i.e., after decryption at the management instance) to determine the protocol used in the communication and test the data for compliance with the protocol (e.g., to identify buffer overflow attempts, injection attempts, malformed packets, etc.). Protections can also be extended to address application-specific concerns, such as monitoring the legitimacy of commands received over the tunnel (e.g., otherwise protocol-compliant commands that deviate from what is expected, such as repeated commands to turn a pump on and off during a short duration (i.e., in an attempt to cause a malfunction or damage to the pump)) and blocking or suspending commands that violate rules for the device, among other examples. Additional network control functionality can also be provided at the management instance 315, such as a terminating proxy that re-generates clean packets from data received by the management instance before forwarding these to the application instance (e.g., to guarantee that packets passed to the application instance are “clean”, regardless of whether the incoming packets were malformed or not). Further authentication, authorization, and accounting (AAA) functionality (e.g., 510) can be provided to pre-authenticate devices and software attempting to communicate with the application instance 320 prior to allowing the connection to be made and data to be sent targeting the application instance 320 (e.g., whether the application initiates the communication or not).

The management instance, in some implementations, can be positioned between the application instance and memory, to guard against malicious data in memory (e.g., loaded directly at the device) from reaching the application and being used by the application (e.g., to compromise operation of the system component controlled by the application), before being screened by the management instance (e.g., using antivirus, whitelisting, etc.). Accordingly, the management instance can “own” all peripherals of the platform system (e.g., SD card reader, USB ports, etc.) and the file system (although keyboard and mouse can be owned by the application instance). This can guard against malware or other threats from being introduced through such peripherals (e.g., locally).

Security tools of the management instance can be complimented by real-time security provided through a management agent 515 provisioned on the management instance 315. The management agent 515 interfaces both with the security tools on the management instance (e.g., via application control, change control, etc.) and with backend security systems, including a central management monitoring system 524, AAA services 526, situational awareness systems 528, and other services. In some implementations, AAA component 510 can likewise (or instead) provide the interface between the management instance and at least a portion of the AAA service 526. AAA services 526, as an example, can provide authorization (e.g., via Kerberos) to allow two devices (e.g., the platform and an external endpoint device) to communicate with each other in a trusted fashion. Further, a secure communication channel can be established between the management agent 515 and the trusted backend services (e.g., 524, 526, 528) such as through a Transport Layer Security (TLS) tunnel, a virtual private network connection, or other examples.

The management agent 515 can monitor events on the management instance 315 as generated, for instance, by security tools (e.g., 504, 506, 508, 510, etc.) and can report these to one or more of the backend services. Further, the management agent 515 can collect information relating to interactions and activities of the management instance, its operating system and various security tools, including the processing and management, by the management instance, of application instance 320 network connections and memory accesses. Further, the functionality of the management agent can be extended, for instance, through agent plug-ins 516, such as plug-ins allowing application control, and change control management, among other example functionality. Such plug-ins 516 can be provided to the management instance 515 from a trusted backend service, such as central management service 524, including dissolvable plug-ins provided to address an immediate need detected by a backend service based on feedback information reported by the management agent.

The management agent 515 effectively has a view of all activity at the management instance 315 as well as a view of activity at the application instance based on the network and memory access activity of the applications 330, as intercepted by the management instance 315. In some implementations, this feedback information can be reported to a backend situational awareness engine 528 that can assess the information to identify likely application behavior, user behavior, or situational contexts at the applications 330 based on the information. For instance, the situational awareness engine 528 can be configured to identify trends, patterns, and heuristics that correspond to particular situations, including situations that are specific and relevant to a business context of the system in which the application(s) are used. Additionally, the situational awareness engine, and other backend services (e.g., 524), can interface with multiple different management agents on multiple management instances across a system and determine situational context based on information received from two or more of these management agents.

For instance, within a nuclear power plant or other industrial plant making use of pumps or valves to control sensitive equipment of the plant, a malicious attacker might attempt to gain control of a the valve or pump controller and cause the controller to attempt to break the equipment or initiate a dangerous outcome using the equipment. For instance, the situational awareness engine can identify a request sent by the application to turn a switch on and off and identify that this activity is irregular (e.g. beyond an established statistical baseline determined (e.g., from agent feedback data) for expected uses of the switch and controller). Another example may be that an expected request is received, but at an unusual time, from an unusual source, at an unusual frequency, or reflecting another anomaly on the platform device. Anomalies can also be detected across devices, such as where certain devices have all attempted to reach out to a specific location and have all (or mostly all) been denied. One instance of an anomalous event may be uninteresting in isolation, but having this event occur (and detecting the event) across multiple systems may be regarded as very peculiar.

The situational awareness engine can correlate and aggregate the information received from the agent (as well as other agents on other devices′) to determine alert conditions or changes in security state for a given device, and do so dynamically (and predictively) in near real time. For instance, the agent can collect log files of the management instance 315 and forward all of this information to a backend security service, such as the situational awareness engine 528. The alert or state change may indicate a detected potential or likely ongoing or future attempt to compromise the management instance (e.g., by a malicious actor)). The situational awareness engine 528 can communicate alerts, events, state changes, etc. determined at the situational awareness engine (based on data received from one or more management agents) to the central management and monitoring engine (e.g., 324) that can push down policies or policy updates to the agent to address the alert or state change.

As noted above, attempts to attack and take-over the management instance 315 can be forecast based on events occurring at the management instance 315. For instance, multiple unsuccessful log-in attempts, attempts to access unauthorized files, attempts to perform actions for which the user does not have authorization, and other attempts and actions can be identified by a management agent 515 and reported to a situational awareness agent 528. While the attempts may be harmless in isolation, a combination or series of such attempts may be evidence of an attack. Further, breaches of safeguards within the management instance 315 can be identified and dealt with in real time to lock-down management instance facilities before further progress is made in the attack.

In one implementation, the situational awareness engine generates alarms, which set “tags” on assets in the management instance to cause policies to be pushed down to those assets based on the new state, cause notifications to be sent to appropriate personnel, etc. As an illustrative example, repeated failed log-in attempts followed by a successful login attempt (i.e., implying that someone brute-forced a weak password on the system) can be detected by a management agent 515 together with other events relating to a network connection. Data describing the same can be communicated up to the security service by the agent causing the situational awareness engine 528 to trigger an alert (e.g., based on a determination that this pattern of actions corresponds to a possible brute force attack). This alert can trigger a policy to be pushed down to the agent 515 to be applied at the management instance 315 to cause network activities to cease, memory accesses to be limited, communications from a corresponding user or source to be blocked, among other example countermeasures responsive to the possible situation of a malicious actor attempting to compromise the platform.

Alerts can be based on determining deviations beyond threshold behavioral profiles for a management instance 315. A baseline can be recorded (e.g., on the management and/or application instance, and/or based on monitoring other deployments of the platform possessing respective management agents) to indicate the types, amount, and timing of activities that are expected at a management instance. Correlation logic (e.g., of a situational awareness engine 528) can store each atomic component of this baseline for use in comparing subsequent conditions described in incoming data reported by the agent to determine whether activity at the management instance 315 deviates beyond a corresponding threshold. Further, by monitoring activity as it occurs on the device, precursors to a known type of attack can be identified. Attacks can be progressive in nature and thus, with each succeeding detected precursor, the state of the platform (and assigned policies) can be dynamically adjusted so as to anticipate subsequent, more damaging actions in an attack (i.e., following the precursor activities). The policies that are pushed down in response can be used to make the management instance 315 a “moving target” that responds evasively to the potential attach and eventually locks down before the management instance is effectively compromised and the application (and its sensitive components) are exposed.

In addition to determining deviations from expected behavior of a single component, or node, the situational awareness can also calculate risk scores for each node in a system and monitor how these nodes interact, the connections between the nodes, and use this information to identify how risk on one node might potentially threaten another node in the system that it communicates with. For instance, based on risk or threatening activity on other nodes in a network, the situational awareness engine can push down policy proactively in anticipation that similar threats may arrive at these other nodes (based on what was observed on another node). Indeed, all or a portion of the nodes can be implemented using similar virtualized platforms including a respective management instance and application instance, as well as management agents reporting conditions on the corresponding platform. When such platforms are installed across a system, enforcing (and updating) system policies can be enforced and updated consistently across the system, and the respective management instances, in communication with one or more centralized backend management services, can orchestrate a combined and complimentary response to attacks of the system.

In some implementations, situational awareness engine 528 can communicate and interoperate with a central management service 524. Indeed, in some cases, central management service 524 can include the situational awareness engine 528. The situational awareness engine 528 can identify a potential threat or attack based on information collected and reported by the management agent 515 and can notify the central management system 524 of its results. The central management system 524 can push down policies and/or plug-ins to the management agent 515 to address the potential threat. The management agent 515 can be used to enforce an updated (and, in some cases, temporary) policy by communicating with one or more systems and security tools (e.g., 502, 504, 506, 508, 510, 512) of the management instance 515 to cause the security tools to adjust their operations to accommodate the new or updated policy received from the central management server 524. In this way, a feedback loop can be established allowing the central management service 524 to dynamically determine policies to apply at one or more management instances in real time in response to detected or forecast threats detected within the system. Indeed, threats detected at one management instance or security tool in a system can cause policies and countermeasures to be proactively pushed (through respective management agents) to multiple other computing devices within the same physical or business system governed by the same policies and managed by the same centralized management system(s).

In addition to the features described above, management agents, agent plug-ins, or other tools can be provided. For instance, in some implementations, application control can be provided at the management instance 315. Application control, before launching any application or software tool (e.g., security tools) within the management instance, may first measure the signature of each executable that is to execute on the management instance to test to see if the signature matches a listing of preapproved signatures of pre-approved tools deployed on the management instance (i.e., and identify any unauthorized modification or malware that may have been added to the management instance). This can effectively provide enforcement of an application whitelist on the management instance 315 such that any modification (in particular malicious modifications) of a software tool of the management instance is not only identified, but blocked. The application control can further report any instances of an application signature mismatch and facilitate the servicing of the effected application.

In some implementations, change control can be provided at the management instance 315. Change control logic can assess configuration files of the management instance 315 by comparing the signature of each configuration file to the signature of the original configuration files to determine if the current configuration has been modified. This can prevent configuration files from being used (e.g., by the management instance) that deviate from those in its original or latest approved deployment, and thereby prevent unauthorized or malicious modifications of management instance configurations from jeopardizing the security provided by the management instance 315 to the application instance 320.

Hardware-based security can be provided at the hardware of a platform system. Each computing device hosting the platform's virtualization environment can make use of hardware (e.g., processor 305) that supports the virtualization as well as enhanced hardware-based security features, such as a Trusted Platform Module (TPM), among other features. The on-box security can leverage processors with hardware-based virtualization hooks implemented on a hypervisor as well as hardware-based security features (e.g., TPM).

One or more of such security features (or other hardware-based security) can also be virtualized at each of the virtual hardware of the management instance, communication manager, and application instance, such as virtual TPM, among other examples. The communication manager can additionally provide security controls to secure communications between the management instance and application instance, among other features shown and described, both implicitly, inherently, and explicitly.

While the application 330 retains its own operating system (e.g., 501) in its corresponding application instance 320 (which, in some cases, may be full of vulnerabilities (e.g., Windows NT)) as virtualized by the hypervisor, the management instance can be built on a separate operating system (e.g., 502) and platform laden with security tools and functionality (e.g., memory randomization, AAA checks, secure UEFI boot measurement, and runtime security (e.g., handled using a management agent in connection with one or more backend security services)) to make security of the management instance as robust as possible (as this is effectively the only piece of the component's software that can be directly accessed by users and outside sources with access to the physical hardware hosting the platform. This can thereby make up for the potentially many vulnerabilities inherent in the application's native operating system 501 and shield complete access to the application 330.

In general, “servers,” “devices,” “computing devices,” “host devices,” “user devices,” “clients,” “servers,” “computers,” “systems,” etc. can include electronic computing devices operable to receive, transmit, process, store, or manage data and information associated with the computing environment. As used in this document, the term “computer,” “computing device,” “processor,” or “processing device” is intended to encompass any suitable processing device adapted to perform computing tasks consistent with the execution of computer-readable instructions. Further, any, all, or some of the computing devices may be adapted to execute any operating system, including Linux, UNIX, Windows Server, etc., as well as virtual machines adapted to virtualize execution of a particular operating system, including customized and proprietary operating systems.

Host and user devices can further computing devices implemented as one or more local and/or remote client or end user devices, such as personal computers, laptops, smartphones, tablet computers, personal digital assistants, media clients, web-enabled televisions, telepresence systems, gaming systems, multimedia servers, set top boxes, smart appliances, in-vehicle computing systems, and other devices adapted to receive, view, compose, send, or otherwise interact with, access, manipulate, consume, or otherwise use applications, programs, and services served or provided through servers within or outside the respective device (or environment). A host device can include any computing device operable to connect or communicate at least with servers, other host devices, networks, and/or other devices using a wireline or wireless connection. A host device, in some instances, can further include at least one graphical display device and user interfaces, including touchscreen displays, allowing a user to view and interact with graphical user interfaces of applications, tools, services, and other software of provided in environment. It will be understood that there may be any number of host devices associated with environment, as well as any number of host devices external to environment. Further, the term “host device,” “client,” “end user device,” “endpoint device,” and “user” may be used interchangeably as appropriate without departing from the scope of this disclosure. Moreover, while each end user device may be described in terms of being used by one user, this disclosure contemplates that many users may use one computer or that one user may use multiple computers, among other examples.

While some of the systems and solution described and illustrated herein have been described as containing or being associated with a plurality of elements, not all elements explicitly illustrated or described may be utilized in each alternative implementation of the present disclosure. Additionally, one or more of the elements described herein may be located external to a system, while in other instances, certain elements may be included within or as a portion of one or more of the other described elements, as well as other elements not described in the illustrated implementation. Further, certain elements may be combined with other components, as well as used for alternative or additional purposes in addition to those purposes described herein.

Further, it should be appreciated that the examples presented above are non-limiting examples provided merely for purposes of illustrating certain principles and features and not necessarily limiting or constraining the potential embodiments of the concepts described herein. For instance, a variety of different embodiments can be realized utilizing various combinations of the features and components described herein, including combinations realized through the various implementations of components described herein. Other implementations, features, and details should be appreciated from the contents of this Specification.

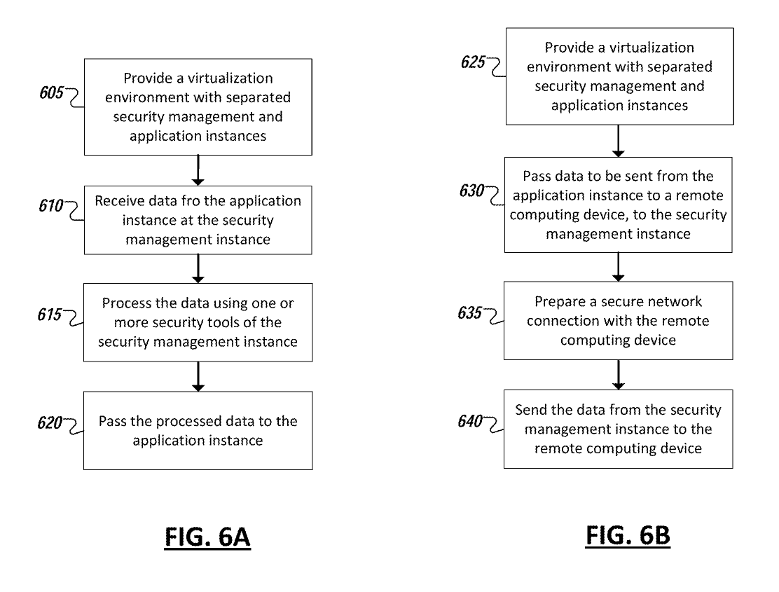

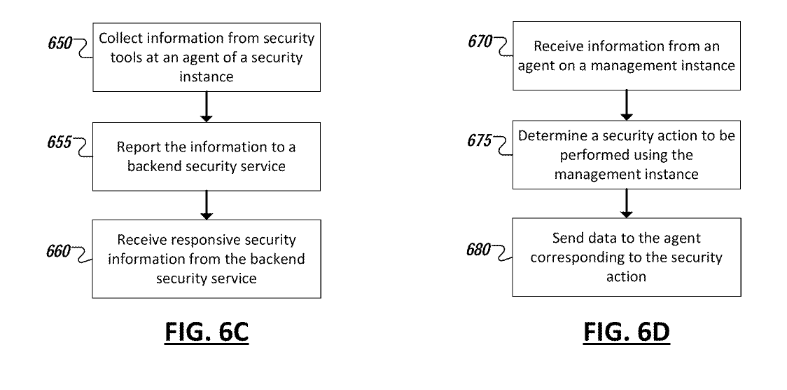

FIGS. 6A-6D are simplified flowcharts 600a-d illustrating example techniques involving a platform system including a virtualization environment that includes a security management instance providing security for a separate application instance. In the example of FIG. 6A, the virtualization environment can be provided 605, and data can be received 610 that is intended for the application instance (e.g., either its application or operating system). The data is intercepted by the security management instance and processed 615 by one or more of the security tools of the security management instance. If, after processing 615, the received data is still fit to be passed to the application instance, the processed data is passed 620 (e.g., using a communication manager) from the security management instance to the application instance. The processed data can be passed to the application instance such that the application instance is not aware of the processing by the security management instance and regards the processed data as originally received over a network from its source.

Turning to FIG. 6B, the virtualization environment can be provided 625 and the security management instance can also perform security for outgoing data communicated by the application instance (e.g., to one or more remote computing devices). The data can be passed 630 from the application instance to the security management instance (e.g., using a communication manager), and in some cases, the security management instance can establish 635 a secure network connection between the platform system and the destination computing device. The secure connection can be established, for instance, by authenticating or otherwise approving the destination computing device, establishing a VPN connection, among other examples. The data can then be sent from the security management instance to the remote computing device (again, without the application instance appreciating the security interventions of the security management instance).

Turning to FIG. 6C, a management agent can be provided in connection with a security management instance. The management agent can collect 650 information regarding activities monitored by one or more security tools on the security management instance, as well as other information describing functions or interactions of the security management instance. The agent can communicate with one or more backend security services over secure communication links and report 655 the information to the backend security services. Security information can be received 660 from the backend security services in response to the reported information. The security information can be responsive to the content of the reported information and can include results of behavioral or situational awareness analyses, or other security analyses. In the some cases, the security information can include a policy update, diagnosis, recommended security action, countermeasure, or other information for use at the security management instance in enhancing security, dynamically, in response to the information.

FIG. 6D includes an example use of reported data of a management agent by a backend security service. For instance, information can be received 670 from a management agent deployed in a security management instance protecting an application instance of a platform system. A security action or recommendation can be determined 675 based on the received information. The action can be further determined 675 based on other information received from other agents on other platform systems or other security tools and clients reporting information to the backend service. Data can be sent 680 to the agent to report or deploy the determined action at the security management instance of the platform system.

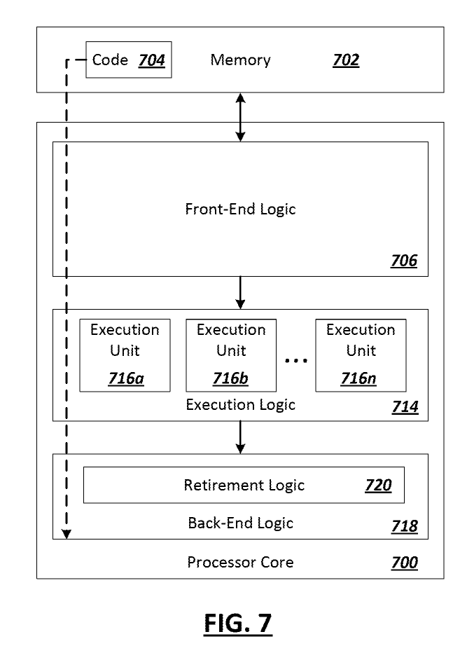

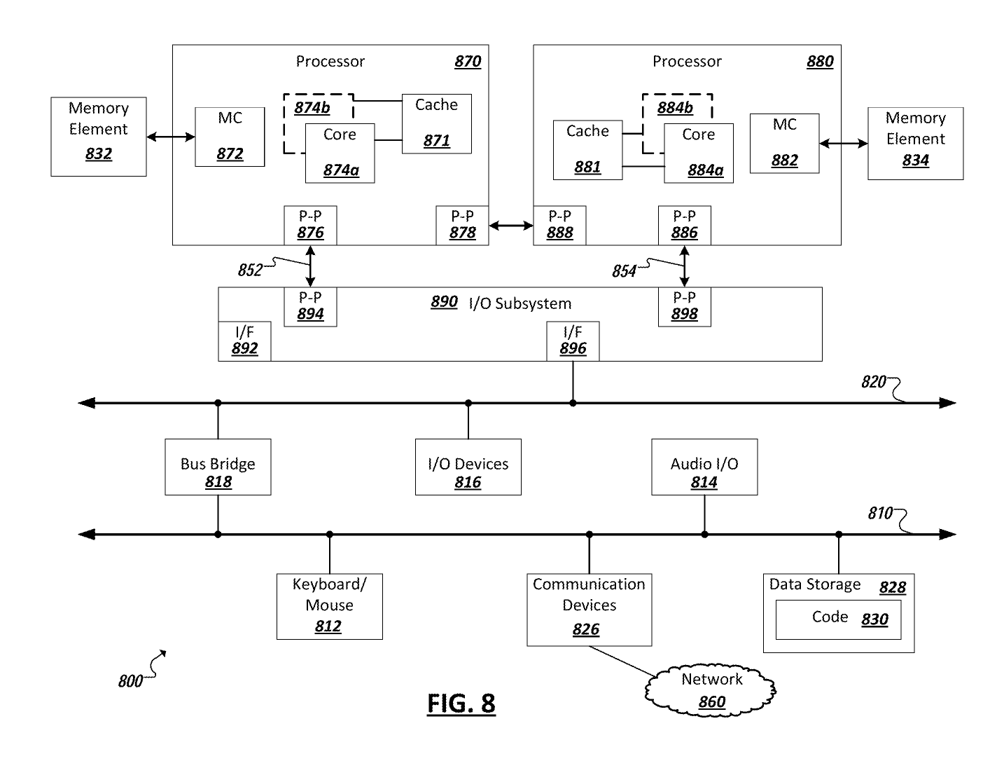

FIGS. 7-8 are block diagrams of exemplary computer architectures that may be used in accordance with embodiments disclosed herein. Other computer architecture designs known in the art for processors and computing systems may also be used. Generally, suitable computer architectures for embodiments disclosed herein can include, but are not limited to, configurations illustrated in FIGS. 7-8.

FIG. 7 is an example illustration of a processor according to an embodiment. Processor 700 is an example of a type of hardware device that can be used in connection with the implementations above.

Processor 700 may be any type of processor, such as a microprocessor, an embedded processor, a digital signal processor (DSP), a network processor, a multi-core processor, a single core processor, or other device to execute code. Although only one processor 700 is illustrated in FIG. 7, a processing element may alternatively include more than one of processor 700 illustrated in FIG. 7. Processor 700 may be a single-threaded core or, for at least one embodiment, the processor 700 may be multi-threaded in that it may include more than one hardware thread context (or “logical processor”) per core.

FIG. 7 also illustrates a memory 702 coupled to processor 700 in accordance with an embodiment. Memory 702 may be any of a wide variety of memories (including various layers of memory hierarchy) as are known or otherwise available to those of skill in the art. Such memory elements can include, but are not limited to, random access memory (RAM), read only memory (ROM), logic blocks of a field programmable gate array (FPGA), erasable programmable read only memory (EPROM), and electrically erasable programmable ROM (EEPROM).

Processor 700 can execute any type of instructions associated with algorithms, processes, or operations detailed herein. Generally, processor 700 can transform an element or an article (e.g., data) from one state or thing to another state or thing.

Code 704, which may be one or more instructions to be executed by processor 700, may be stored in memory 702, or may be stored in software, hardware, firmware, or any suitable combination thereof, or in any other internal or external component, device, element, or object where appropriate and based on particular needs. In one example, processor 700 can follow a program sequence of instructions indicated by code 704. Each instruction enters a front-end logic 706 and is processed by one or more decoders 708. The decoder may generate, as its output, a micro operation such as a fixed width micro operation in a predefined format, or may generate other instructions, microinstructions, or control signals that reflect the original code instruction. Front-end logic 706 also includes register renaming logic 710 and scheduling logic 712, which generally allocate resources and queue the operation corresponding to the instruction for execution.

Processor 700 can also include execution logic 714 having a set of execution units 716a, 716b, 716n, etc. Some embodiments may include a number of execution units dedicated to specific functions or sets of functions. Other embodiments may include only one execution unit or one execution unit that can perform a particular function. Execution logic 714 performs the operations specified by code instructions.

After completion of execution of the operations specified by the code instructions, back-end logic 718 can retire the instructions of code 704. In one embodiment, processor 700 allows out of order execution but requires in order retirement of instructions. Retirement logic 720 may take a variety of known forms (e.g., re-order buffers or the like). In this manner, processor 700 is transformed during execution of code 704, at least in terms of the output generated by the decoder, hardware registers and tables utilized by register renaming logic 710, and any registers (not shown) modified by execution logic 714.

Although not shown in FIG. 7, a processing element may include other elements on a chip with processor 700. For example, a processing element may include memory control logic along with processor 700. The processing element may include I/O control logic and/or may include I/O control logic integrated with memory control logic. The processing element may also include one or more caches. In some embodiments, non-volatile memory (such as flash memory or fuses) may also be included on the chip with processor 700.

FIG. 8 illustrates a computing system 800 that is arranged in a point-to-point (PtP) configuration according to an embodiment. In particular, FIG. 8 shows a system where processors, memory, and input/output devices are interconnected by a number of point-to-point interfaces. Generally, one or more of the computing systems described herein may be configured in the same or similar manner as computing system 800.

Processors 870 and 880 may also each include integrated memory controller logic (MC) 872 and 882 to communicate with memory elements 832 and 834. In alternative embodiments, memory controller logic 872 and 882 may be discrete logic separate from processors 870 and 880. Memory elements 832 and/or 834 may store various data to be used by processors 870 and 880 in achieving operations and functionality outlined herein.

Processors 870 and 880 may be any type of processor, such as those discussed in connection with other figures. Processors 870 and 880 may exchange data via a point-to-point (PtP) interface 850 using point-to-point interface circuits 878 and 888, respectively. Processors 870 and 880 may each exchange data with a chipset 890 via individual point-to-point interfaces 852 and 854 using point-to-point interface circuits 876, 886, 894, and 898. Chipset 890 may also exchange data with a high-performance graphics circuit 838 via a high-performance graphics interface 839, using an interface circuit 892, which could be a PtP interface circuit. In alternative embodiments, any or all of the PtP links illustrated in FIG. 8 could be implemented as a multi-drop bus rather than a PtP link.

Chipset 890 may be in communication with a bus 820 via an interface circuit 896. Bus 820 may have one or more devices that communicate over it, such as a bus bridge 818 and I/O devices 816. Via a bus 810, bus bridge 818 may be in communication with other devices such as a keyboard/mouse 812 (or other input devices such as a touch screen, trackball, etc.), communication devices 826 (such as modems, network interface devices, or other types of communication devices that may communicate through a computer network 860), audio I/O devices 814, and/or a data storage device 828. Data storage device 828 may store code 830, which may be executed by processors 870 and/or 880. In alternative embodiments, any portions of the bus architectures could be implemented with one or more PtP links.

The computer system depicted in FIG. 8 is a schematic illustration of an embodiment of a computing system that may be utilized to implement various embodiments discussed herein. It will be appreciated that various components of the system depicted in FIG. 8 may be combined in a system-on-a-chip (SoC) architecture or in any other suitable configuration capable of achieving the functionality and features of examples and implementations provided herein.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. In certain implementations, multitasking and parallel processing may be advantageous. Additionally, other user interface layouts and functionality can be supported. Other variations are within the scope of the following claims.

In general, at least some aspects of the subject matter described in this specification can be embodied in apparatus, systems, machine readable storage, machine readable media, hardware- and/or software-based logic, and methods to provide a virtualization environment to include a security management instance and an application instance. The application instance is separated from the security management instance, the application instance is to include a first operating system and a particular software application, and the security management instance is to include a second operating system and one or more security tools to provide security for the particular application. Data for the application instance is received at the security management instance, the data is processed using at least one of the security tools, and the processed data is securely passed from the security management instance to the application instance.

In at least some examples, the first operating system is different from the second operating system and the second operating system possesses one or more enhanced security features. The security provided by the security management instance can be invisible to the particular application. The provided security can include intercepting network communications involving the particular application at the security management instance and processing the communications prior to allowing the network communications to proceed to their destination. The communications can be processed using one or more of the security tools. The security management instance can open a virtual private network (VPN) tunnel for the communications on behalf of the application instance, and the application instance is unaware of the VPN tunnel. The communications can involve another entity and the security management instance can authenticate and authorize the entity for communications with the application instance on behalf of the application instance. Memory access attempts by the application instance can be intercepted and approved by the security management instance prior to the application instance accessing the memory.

In at least some examples, the data is passed between the application instance and security management instance by a communication manager implemented in the virtualization environment. The communication manager can include a shared memory structure for access by both the application instance and security management instance to emulate a network connection between the application instance and security management instance. The security tools can include a management agent to monitor activity at the security management instance and communicate information describing the monitoring to a remote security management system. The management agent can collect information to report security information related to the application instance to the security management system and can receive policy information to apply at the security management instance from the security management system. The virtualization environment can be implemented through an embedded hypervisor. The application can manage physical equipment in a system. The processed data can be used by the particular application.

In at least some implementations, a system can be provided that includes a processor including one or more hardware security functions and a hypervisor to provide a virtualization environment including an application instance, a security instance, and a communication manager. The application instance can include a first operating system and at least one particular application. The security management instance can include one or more security tools to provide security for the particular application. The security can be invisible to the application instance. A communication manager can provide a secure communication channel between the application instance and the security management instance. The hypervisor can be launched using a secure boot.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. At least one machine accessible storage medium having instructions stored thereon, the instructions when executed on a machine, cause the machine to:
provide a virtualization environment to comprise a security management instance and an application instance, wherein the application instance is separated from the security management instance, the application instance is to comprise a first operating system and a particular software application, and the security management instance is to comprise a second operating system and one or more security tools to provide security for the particular application;
receive data for the application instance at the security management instance;
process the data using at least one of the security tools; and
securely pass the processed data from the security management instance to the application instance.

2. The storage medium of claim 1, wherein the first operating system is different from the second operating system and the second operating system possesses one or more enhanced security features.

3. The storage medium of claim 1, wherein the security provided by the security management instance is invisible to the particular application.

4. The storage medium of claim 1, wherein the provided security comprises intercepting network communications involving the particular application at the security management instance and processing the communications prior to allowing the network communications to proceed to their destination.

5. The storage medium of claim 4, wherein the communications are processed using one or more of the security tools.

6. The storage medium of claim 4, wherein the security management instance is to open a virtual private network (VPN) tunnel for the communications on behalf of the application instance, and the application instance is unaware of the VPN tunnel.

7. The storage medium of claim 4, wherein the communications are to involve another entity and the security management instance is to authenticate and authorize the entity for communications with the application instance on behalf of the application instance.

8. The storage medium of claim 1, wherein memory access attempts by the application instance are to be intercepted and approved by the security management instance prior to the application instance accessing the memory.

9. The storage medium of claim 1, wherein the data is passed between the application instance and security management instance by a communication manager implemented in the virtualization environment.

10. The storage medium of claim 9, wherein the communication manager comprises a shared memory structure for access by both the application instance and security management instance to emulate a network connection between the application instance and security management instance.

11. The storage medium of claim 1, wherein the one or more security tools comprises a management agent to monitor activity at the security management instance and communicate information describing the monitoring to a remote security management system.

12. The storage medium of claim 11, wherein the management agent is to collect information to report security information related to the application instance to the security management system and is to receive policy information to apply at the security management instance from the security management system.

13. The storage medium of claim 1, wherein the virtualization environment is implemented through an embedded hypervisor.

14. The storage medium of claim 1, wherein the application is to manage physical equipment in a system.

15. The storage medium of claim 1, wherein the processed data is to be used by the particular application.

16. A method comprising:
loading a virtualization environment comprising a security management instance and an application instance, wherein the application instance is separated from the security management instance, the application instance is to comprise a first operating system and a particular software application, and the security management instance is to comprise a second operating system and one or more security tools to provide security for the particular application;
receiving data for the application instance at the security management instance;
processing the data using at least one of the security tools; and
securely passing the processed data from the security management instance to the application instance.

17. The method of claim 16, further comprising:
reporting attributes of the data to a remote security service using the security management instance, wherein the attributes are reported using a secure connection with the security service;
receiving, at the security management instance, a policy update from the security service based on the reported attributes; and
causing the policy update to be applied at one or me of the security tools.

18. The method of claim 17, wherein the policy update is determined based on a situational awareness result determined at the security service based on the attributes.

19. A system comprising:
a processor comprising one or more hardware security functions;
a hypervisor to provide a virtualization environment comprising:
an application instance comprising:
a first operating system;
a particular application;
a security management instance comprising:
one or more security tools to provide security for the particular application, wherein the security is invisible to the application instance; and
a communication manager to provide a secure communication channel between the application instance and the security management instance.

20. The system of claim 19, wherein the hypervisor is to be launched using a secure boot.
